(19) United States
(12) Patent Application Publication
(10) Pub. No.: US 2022/0325130 A1
(43) Pub. Date: Oct. 13, 2022

(54) COATING COMPOSITION

(71) Applicant: Steuler Korrosionsschutz Holding GmbH, Siershahn (DE)

(72) Inventors: Christian DUTSCHKE, Hundsdorf (DE); Ralf MARCKS, Königswinter (DE); Iris ZWICK, Rheinbrohl (DE)

(21) Appl. No.: 17/640,072

(22) PCT Filed: Sep. 4, 2020
(86) PCT No.: PCT/EP2020/074843

§ 371 Date: Mar. 3, 2022

(30) Foreign Application Priority Data
Sep. 4, 2019 (EP) 19195358.7

(51) Int. Cl. C09D 163/10

(52) U.S. Cl. CPC C09D 163/10; C08K 3/34

(57) ABSTRACT

A binder composition comprising
50 to 80% by weight of an acrylate ester of an epoxy-novolac resin,
20 to 49% by weight of mono-, di- or trifunctional acrylates,
0.1 to 2% by weight of a starter,
0 to 10% by weight of other auxiliaries,
   wherein said binder composition essentially has no components that have a boiling point below 200° C. under normal pressure.

The present invention relates to a binder composition.

In many technical fields, a wide variety of reactive resin systems are used in order to achieve the desired properties for the respective use.

One field of application of such reactive resin systems is the coating of surfaces against solvents and chemicals having an oxidizing effect. Such coating systems are employed, for example, in the chemical industry, in petroleum processing, in refineries, in wastewater treatment, in ore processing plants, in water protection, in chemical stores, reactors, conduits, collection basins and pits, canals etc.

Typical systems include: Asplit VEL, Asplit LF, Asplit LC, all available from REMA TipTop, Ceilcote Lining 74, Ceilcote Flakeline 232 (222, 282), all available from International Paint, Chemflake Special, available from Jotun, Bücolit V47-36, available from GBT-Bücolit, and many more. These are systems produced from substances that may be hazardous to health. Typically, vinyl esters are reactively diluted with monostyrene, and the use of furfuryl alcohol, furfural, formaldehyde or phenol is typical.

This results in explosion risks that in part exist from evaporating products when the coating is applied, and on the other hand, the fact that respiratory protective devices are often prescribed for employees, in order to take safety and workplace protection requirements into account. Therefore, although there are a wide variety of suitable reactive systems, there is still a need for systems that combine excellent properties with lower workplace protection requirements.

Desirable requirements for corresponding coatings include:
processability within a range of from 5 to 40° C.,
simple processing by usual work equipment,
no requirement of explosion protection measures,
no requirement of respiratory protective devices for the employees,
high resistance against organic chemicals, alkalis and acids,
abrasion resistance,
good adhesiveness,
flexibility.

It has been the object of the present invention to provide binder systems that meet at least some of the requirements.

The object is achieved by a binder composition comprising
50 to 80% by weight of an acrylate ester of an epoxy-novolac resin,
20 to 49% by weight of mono-, di- or trifunctional acrylates,
0.1 to 2% by weight of a starter,
0 to 10% by weight of other auxiliaries,
   wherein said binder composition essentially has no components that have a boiling point below 200° C. under normal pressure.

According to the invention, said binder composition contains 50 to 80% by weight of an acrylate ester of an epoxy-novolac resin.

If such products are delivered in mixtures, the stated amounts relate to the content of acrylate ester of the epoxy-novolac resin without considering the other substances in the mixture.

Preferred amounts are 60 to 70% by weight in the binder.

Preferably, the acrylate ester of the epoxy-novolac resin is a triacrylate ester. A preferred product is Ebecryl® 9138 available from Allnex Group.

Further, the binder composition contains mono-, di- or trifunctional acrylates. These are preferably selected from 1,4-butanediol dimethacrylate, 1,6-hexanediol dimethacrylate, tripropylene glycol diacrylate, glycerol dimethacrylate, 1,4-butanediol diacrylate, 1,6-hexanediol diacrylate, polyethylene glycol 200 dimethacrylate, butyldiglycol methacrylate, dicylopentenyloxyethyl methacrylate, dihydroxycyclopentadienyl acrylate, tetrahydrofurfuryl methacrylate, ethyltriglycol methacrylate, trimethylolpropane trimethacrylate, and mixtures thereof.

In this case too, if these are offered in a mixture, only the proportion of mono-, di- or trifunctional acrylates is considered when the weight contents are calculated. Preferred contents are about 30 to 45% by weight.

The above mentioned Ebecryl® 9138 is a mixture of 80% by weight of an acrylate ester of an epoxy-novolac resin and 20% by weight of 1,4-butanediol diacrylate. If Ebecryl® 9138 is employed, preferably, more mono-, di- or trifunctional acrylate is added.

Further, the binder composition contains a starter. For example, azo- or peroxide-based starters have proven suitable as starters, which result in a polymerization reaction in the above stated processing temperature range. The object is to achieve tack-free curing of the surface within a maximum of 24 hours for processing times of at least 25 minutes, and those skilled in the art know how to employ the amounts of accelerator or decelerator accordingly. Preferably, the starter is thermally activated; in such cases, it is reasonable to combine the starter with the remaining components only shortly before use. However, in principle, it is also possible to achieve activation by UV radiation or an electron beam instead of using starters.

The composition may further contain auxiliaries, e.g., accelerators, decelerators, viscosity modifiers, adhesion promoters, etc.

Auxiliaries within the meaning of this application are ingredients that affect the polymerization reaction.

The binder composition according to the invention is usually used together with fillers to form a coating composition. Fillers are inert with respect to the polymerization reaction, but can have an important influence on the properties of the composition, especially on the shrinkage, tightness with regard to reagents, hardness, wear, conductivity. These may include, for example, glass flakes, mica, barium sulfate, or quartz powder. Alternatively, it is possible to cover the surface with, for example, glass fiber fabrics, glass fiber mats, glass fiber pads, and to soak them with the binder. Carbon fibers, for example, may also be used instead of glass fibers. Further fillers include, for example, pigments, baryte, quartzes, silicas, cokes, carbon blacks, graphite, silicon carbide, alumina, and mixtures thereof. The invention also relates to such coating compositions.

In cases where the assignment of a product to auxiliaries or fillers appears to be difficult in spite of the above-mentioned definition, substances that cannot be dissolved completely in the binder composition are considered as fillers. Substances that dissolve are considered as auxiliaries.

In contrast to many products of the prior art, the product according to the invention contains essentially no monostyrene. Therefore, the content of monostyrene is preferably ≤0.05% by weight, more preferably below the measuring limit.

The binder composition according to the invention essentially has no components that have a boiling point below 200° C. under normal pressure. “Essentially” means that the content of ingredients having a boiling point below 200° C. under normal pressure is <1% by weight, based on the total binder composition, preferably <0.5% by weight. Normal pressure corresponds to 1013 mbar.

The invention also relates to a molded part obtainable by curing the binder composition or coating composition according to the invention. Such molded parts may be components or coatings.

The invention also relates to the use of said binder composition or coating composition according to the invention as a protective layer on substrates such as steel-reinforced concrete or steel, as a leveling, trowel-applied or blinded coating, as a synthetic resin putty for laying and grouting tiles or masonry, as container interior coatings or as synthetic resin compositions for preparing polyconcretes.

The present invention further relates to a process for coating a substrate, comprising the steps of
applying said binder composition or coating composition according to the invention to obtain a coating layer,
curing the coating layer.

Said applying may be effected, for example, by laminating, dipping, soaking, trowel-applying, jet-spraying or rolling methods.

The binder composition or coating composition according to the invention is typically mixed extemporaneously. In a simple variant, the acrylate esters of an epoxy-novolac resin, the mono-, di- or trifunctional acrylates, auxiliaries and fillers are premixed; only the starter is added and admixed. However, three or more components may also be mixed on site.

Preferably, irradiation, especially irradiation with UV light, is not necessary for curing. Thus, coatings based on the binder according to the invention can cure completely at room temperature in an economic and practicable way on large surface areas without complicated additional curing measures.

The invention is further illustrated by means of the following further Examples:

### Example 1

66.27 kg of Ebecryl 9138 containing 80% by weight acrylate ester of an epoxy-novolac resin and 20% by weight 1,4-butanediol diacrylate was mixed with 22.22 kg of 1,4-BDDMA containing 90% by weight butanediol dimethacrylate and 11.11 kg of dicyclopentenyloxyethyl methacrylate (FA-512 M, Hitachi Chemicals).

On site, 20 g of accelerator, Accelerator NL-53 (Akzo), containing 60-70% by weight cobalt(II) 2-ethylhexanoate was added as auxiliaries to 10 kg of the above mentioned mixture, and stirred. This was followed by the addition of 200 g of the peroxide-based starter Peroxan CU-80-L (Pergan) containing 80-85% by weight cumene hydroperoxide.

A composition was formed that could be applied to a precleaned substrate. The layer thickness was about 0.8 mm. The product was processable for about 30 min., and the surface was tack-free after 24 hours. The coating reached its full loading capacity after 5 days. It was resistant against acids and alkalis.

### Example 2

The procedure was the same as in Example 1, except that 16 kg of quartz filler Millisil W4 (Quarzwerke) was added with stirring as a filler after the addition of the starter, and well mixed with renewed homogenization. A composition was formed that could be applied to a precleaned substrate.

The layer thickness was about 2 mm. The product was processable for about 30 min., and the surface was tack-free after 24 hours.

The product showed reduced shrinkage stress as compared to Example 1.

### Example 3

The procedure was the same as in Example 2, except that 2 random fiber mats having a base weight of 300 g/m² each, instead of the quartz filler, was embedded into the resin matrix including the starter. The glass content of the total composition was 30%. After curing, a coating was obtained that has a higher mechanical stability.

1. A binder composition comprising
50 to 80% by weight of an acrylate ester of an epoxy-novolac resin,
20 to 49% by weight of mono-, di- or trifunctional acrylates,
0.1 to 2% by weight of a starter,
0 to 10% by weight of other auxiliaries,
wherein said binder composition essentially comprises no components that have a boiling point below 200° C. under normal pressure.

2. The binder composition according to claim 1, wherein said acrylate ester of an epoxy-novolac resin is a triacrylate ester.

3. The binder composition according to claim 1, wherein said mono-, di- or trifunctional acrylates are selected from the group consisting of 1,4-butanediol dimethacrylate, 1,6-hexanediol dimethacrylate, tripropylene glycol diacrylate, glycerol dimethacrylate, 1,4-butanediol diacrylate, 1,6-hexanediol diacrylate, polyethylene glycol 200 dimethacrylate, butyldiglycol methacrylate, dicylopentenyloxyethyl methacrylate, dihydroxycyclopentadienyl acrylate, tetrahydrofurfuryl methacrylate, ethyltriglycol methacrylate, trimethylolpropane trimethacrylate, and mixtures thereof.

4. The binder composition according to claim 1, wherein said starter is an azo-based or peroxide-based starter.

5. The binder composition according to claim 1, wherein said auxiliaries are selected from the group consisting of accelerators, decelerators, viscosity modifiers, adhesion promoters, and mixtures thereof.

6. The binder composition according to claim 1, wherein the content of monostyrene is ≤0.05% by weight.

7. A coating composition comprising from 30 to 70% by weight of the binder composition according to claim 1, and 70 to 30% by weight of fillers.

8. The coating composition according to claim 7, wherein said fillers are selected from the group consisting of glass fibers, glass fabric, carbon fibers, carbon fabric, and non-wovens, glass flakes, mica, graphite flakes, pigments, baryte, quartzes, silicas, cokes, carbon blacks, graphite, silicon carbide, alumina and mixtures thereof.

9. A molded part obtainable by curing the binder composition according to claim 1 or the coating composition according to claim 7.

10. The molded part according to claim 9, wherein said molded part is a component or a coating.

11. (canceled)

12. A process for coating a substrate comprising the steps of
applying the binder composition according to claim 1, to obtain a coating layer,
curing said coating layer.

13. The process according to claim 12, wherein said applying is effected by laminating, dipping, soaking, trowel-applying, jet-spraying or rolling methods.

14. A process for coating a substrate comprising the steps of
applying the coating composition according to claim 7, to obtain a coating layer,
curing said coating layer.

15. The process according to claim 14, wherein said applying is effected by laminating, dipping, soaking, trowel-applying, jet-spraying or rolling methods.
